(19) United States
(12) Patent Application Publication
(10) Pub. No.: US 2002/0103004 A1
(43) Pub. Date: Aug. 1, 2002

(54) Method and apparatus for providing fast mobile-to-mobile data connectivity

(76) Inventors: Dan Vassilovski, Del Mar, CA (US); James Tomcik, Carlsbad, CA (US)

Correspondence Address: Qualcomm Incorporated, Patents Department, 5775 Morehouse Drive, San Diego, CA, 92121-1714, US

(21) Appl. No.: 09/773,402

(22) Filed: Jan. 31, 2001

(51) Int. Cl. H04M 1/00

(52) U.S. Cl. 455/553; 455/552; 455/426

(57) ABSTRACT

Method and apparatus for providing fast mobile-to-mobile connectivity comprising a processor and a storage device coupled to the processor. The storage device contains a set of executable computer instructions for determining if an initial communication from a first wireless communication device operating in a wireless communication system comprises a request to initiate an asynchronous data communication and to identify if a second wireless communication device is operating within the same communication system as the first wireless communication device. If the first wireless communication device has requested an asynchronous communication and the second wireless communication device is operating within the same communication system, the processor routs the asynchronous data communication directly to the second wireless communication device without the use of a modem, thereby eliminating a modem training time.

### BACKGROUND

I. Field

The invention relates to data communications, and more particularly to a method and apparatus for providing fast mobile-to-mobile data connectivity in a wireless communication system.

II. Background

Wireless communications have become commonplace in much of the world with the advent of cellular telephones and wireless data modems. At first, wireless communications were restricted to first generation voice communications using modulation techniques such as Advanced Mobile Phone Service (AMPS), commonly used in the United States. More recently, second generation systems using digital technology for transmitting both voice and data have been developed. Examples of such second generation systems include Code Division Multiple Access (CDMA) and Global System for Mobile communications (GSM).

Digital transmission of data generally occurs in one of two formats, either asynchronously or synchronously. Synchronous data communication is also known as packet data. In both communication formats, data may be transmitted from a wireless communication device, such as a wireless telephone, to a fixed receiver, such as a base station, in discreet units known as packets. The packets are received by the fixed receiver and routed to a destination. In the case of synchronous communications, the packets are routed in accordance with information embedded within each packet. For example, internet protocol (IP) packets are routed to in IP address identified in each IP packet transmitted.

In the case of asynchronous data communications, packets are received by the fixed receiver, and ultimately routed to a bank of modems. The packets are converted into audible tones by one of the modems in the modem bank, and then the tones are sent over the Public Switch Telephone Network (PSTN) to a destination modem. The destination modem converts the audible tones back into packets and then the packets are provided to a destination device connected to the destination modem, such as a computer or a facsimile machine.

When a modem is selected to initiate an asynchronous data call, a modem training occurs, during which the selected modem and the destination modem establish baseline communications with each other. The baseline communications negotiate, for example, a rate at which to send information between the modems. After the modem training procedure is completed, information may then be transmitted between the modems.

One disadvantage of transmitting asynchronous data by a wireless communication device is the initial delay incurred while the modem training procedure is performed. A delay of several seconds is typical.

In present wireless communication systems, when an asynchronous communication is initiated by a first wireless communication device to a second wireless communication device operating within the same communication system as the first wireless communication device, the modem training procedure is performed as usual. However, in this case, the destination modem is generally co-located with the modem selected by the fixed receiver. Nonetheless, a connection is established between the two modems, and the modem training procedure is performed. Again, the delay associated with the modem training procedure is imposed on the first and second wireless communication devices before any data is exchanged.

What is needed is a method and apparatus to minimize the delay associated with the modem training procedure in a communication between two wireless communication devices located within a common communication system.

### SUMMARY

The present invention is directed to a method and apparatus for providing fast mobile-to-mobile data connectivity. In one embodiment, the method and apparatus for providing fast mobile-to-mobile data connectivity comprises an apparatus comprising a processor and a storage device coupled to the processor. The storage device contains a set of executable computer instructions for allowing the processor to determine if an initial communication from a first wireless communication device comprises a request to initiate an asynchronous data communication. The processor further determines an identification code associated with a second wireless communication device, the identification code determined from the initial communication. The processor further determines if the second wireless communication device is operating within the same communication system as the first wireless communication device. The asynchronous data communication is routed to a modem if the initial communication comprises a request to initiate an asynchronous communication and the second wireless communication device is not operating within the same communication system as the first wireless communication device. Otherwise, the asynchronous data communication is routed directly to the second wireless communication device without routing it to the modem if the second wireless communication device is operating within the same communication system as the first wireless communication device.

In another embodiment, the method and apparatus for providing fast mobile-to-mobile data communications comprises a method comprising the steps of receiving an initial communication from a first wireless communication device and determining if said initial communication comprises a request to initiate an asynchronous data communication. An identification code corresponding to a second wireless communication device is then determined, the identification code derived from the initial communication. Next, it is determined if the second wireless communication device is operating within the same communication system as the first wireless communication device. The asynchronous data communication is routed to a modem if the second wireless communication device is not operating within the same communication system as the first wireless communication device. Otherwise, the asynchronous data communication is routed directly to the second wireless communication device without routing it to the modem if the second wireless communication device is operating within the same communication system as the first wireless communication device.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 illustrates a wireless communication system comprising the method and apparatus for providing fast mobile-to-mobile data connectivity;

FIG. 2 is a functional block diagram of a base station controller located within the communication system of FIG. 1 illustrating the various components comprising the apparatus for providing fast mobile-to-mobile data connectivity; and

FIG. 3 is a functional flow diagram of the method of providing fast mobile-to-mobile data connectivity.

### DETAILED DESCRIPTION

The present invention is directed to a method and apparatus for providing fast mobile-to-mobile data connectivity. Specifically, fast mobile-to-mobile data connectivity refers to an asynchronous data communication between a first wireless communication device and a second wireless communication device when the two wireless communication devices are operating within a common communication system.

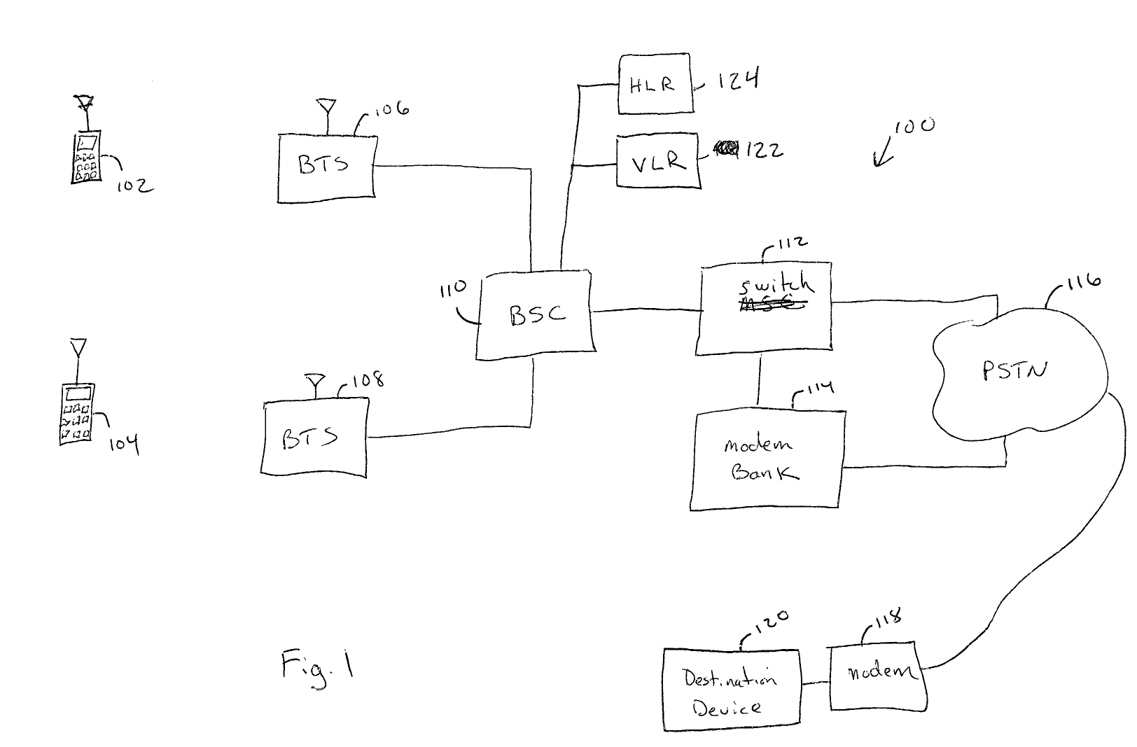

FIG. 1 illustrates a wireless communication system 100 comprising the method and apparatus for providing fast mobile-to-mobile data connectivity. Wireless communication devices (WCDs) 102 and 104 communicate with basestation transceivers (BTSs) 106 and/or 108 wirelessly using one or more well-known air-interfaces, such as code division multiple access (CDMA), time division multiple access (TDMA), global system for mobile communications (GSM), or others. WCD 102 and 104 are shown in FIG. 1 comprising cellular telephones, although it should be understood that WCD 102 and 104 could alternatively comprises a variety of electronic devices, such as a still camera, a video camera, a portable or fixed computer, a data collection device, a combination of the aforementioned, or other well-known electronic devices.

In one embodiment, WCDs 102 and 104 are capable of transmitting and receiving both voice and data communications to and from BTS 106 and/or 108. Voice communications typically comprise transmitting human speech from a WCD to a destination device, such as a cellular telephone, a landline telephone, a or a voice-capable computer. Data communications generally comprise the transmission of data files, including such applications as facsimile transmission, email, internet access, audio and video streaming applications, and voice-over-data applications. Data communications typically comprise one of two types: asynchronous or synchronous data communications.

Synchronous communications, otherwise known as packet data communications, generally refer to sending information in discreet units called packets. Each data packet generally comprises information relating to a data address corresponding to a destination device to which the data packets are intended. One example of a data address is an Internet Protocol address, or IP address. A typical IP address comprises four fields, each field ranging from 0 to 255, uniquely identifying the destination device, which is connected to a data network such as the Internet. Data packets are transmitted over the data network, typically through a number of different paths, and may arrive in a different order than they were originally sent.

Asynchronous communications, on the other hand, rely on sending digital information over a dedicated transmission path. A common example of asynchronous communications is a facsimile machine transmitting information over the PSTN to a second facsimile machine. The first facsimile machine establishes a dedicated connection over the Public Switched Telephone Network (PSTN) 116 with the second facsimile machine. Once the connection is established, data is exchanged between the facsimile machines over the dedicated circuit provided by the PSTN. Note that in asynchronous communications, the transmitted information generally does not contain information identifying the destination device.

When an asynchronous data communication is initiated by a WCD in communication system 100, an initial communication is transmitted from WCD 102 to BTS 106, for example. In one embodiment, the initial communication comprises an origination message, which is commonly used in the wireless telecommunication industry to initiate communications between a WCD and a fixed receiver, such as a base station. An origination message comprises information needed to establish a connection with a desired destination device. The origination message is received by BTS 106, and then provided to base station controller (BSC) 110. BSC 110 coordinates the activities of multiple base station transceivers (BTS's) including WCD registrations and handoff as WCDs travel between coverage areas of the various BTSs in communication system 100.

In prior art communication systems, the origination message is provided to switch 112. Switch 112 is responsible for establishing an initial connection with the desired destination device and allocating resources for maintaining the subsequent communication to the desired destination device. It is also responsible for other functions as well, such as billing and other functions.

In order to determine how to allocate resources to establish the communication, switch 112 interrogates the origination message to determine an identification code corresponding to the desired destination device. The identification code typically comprises a series of digits, such as a telephone number. Once the identification code is known, switch 112 queries visitor location register (VLR) 122 and/or home location register (HLR) 124 to determine if the desired destination device is a WCD operating within communication system 100. If the desired destination device is not operating within communication system 100, then the data communication must be sent outside communication system 100, generally by sending the data communication to PSTN 116 to the desired destination device. For example, if the identification code corresponds to a WCD whose “home location” is communication system 100, then an entry will be found within HLR 124. If the WCD is operating within a communication system other than communication system 100, then an indication of such will be found in HLR 124, informing switch 112 where to find the WCD in the other communication system. Switch 112 then initiates communications with the WCD by allocating resources to provide a connection to PSTN 116, which in turn routes the subsequent asynchronous data communication to the desired destination device.

It should be understood that the term “operating within communication system 100” herein is not limited to only the components shown in FIG. 1. Switch 112 typically supports more than one BSC 110. Therefore, “operating within communication system 100” is defined as a WCD operating within the coverage area supported by any BSC serviced by switch 112.

If switch 112 determines that the desired destination device is not located within communication system 100, a modem is generally used to transmit the data communication across the PSTN. As shown in FIG. 1, switch 112 accesses modem bank 114 to select such a modem. Modem bank 114 comprises a number of modems, each modem for converting electronic signals into a format which can be transmitted over the PSTN and vice-versa. A common example is a modem which converts the digital signals from switch 112 into audible tones which are transmitted over PSTN 116 to a modem 118, also connected to PSTN 116. Modem 118, in turn, is connected to the desired destination device 120. The audible tones from the selected modem within modem bank 114 are converted back into electrical signals by modem 118 for use by destination device 120. Generally, two way communications are possible once the modem-to-modem connection has been established.

In a prior art communication system, if switch 112 determines that the desired destination device is operating within communication system 100, then an initial communication is established by switch 112, again using modem bank 114. That is, a first modem is selected by switch 112 used to convert electrical signals from WCD 102 into audible tones. However, because the destination device is a second WCD operating within communication system 100, the output of the first modem is connected to the input of a second modem within modem bank 114. The second modem receives the audible tones from the first modem, and converts them into electronic signals, where they are routed to the second WCD through BSC 110 and a BTS corresponding to a coverage area where the second WCD is operating.

Unfortunately, there is generally a time delay associated with the initialization of the modems within modem bank 114, as well as with other modems connected to PSTN 116. When a first modem contacts a second modem, a modem training period commences in which the two modems negotiate various communication parameters, such as tone, volume, and baud rate. The modem training period introduces a measurable time delay between when WCD 102 sends an origination message and when data can actually begin to be transmitted from WCD 102. When the desired destination device is located in a communication system other than the communication system in which WCD 102 is located, the communication generally must be routed through a first modem associated with switch 112, across PSTN 116, and then to a second modem connected to PSTN 116. In prior art communication systems, if the desired destination device is located within the same communication system as WCD 102, the communication is still routed to switch 112, through a first modem located within modem bank 114, then to a second modem, also located within modem bank 114, then onto switch 112, BSC 110, a BTS associated with the desired destination device, and finally to the desired destination device.

The present invention, therefore, is directed to a method and apparatus for providing fast mobile-to-mobile data connectivity in a wireless communication system when a first WCD and a second WCD are operating within the same communication system 100. As used herein, communication system 100 refers to BSC 110 and any BTS which is able to communicate with BSC 110. Therefore, a WCD operating within communication system 100 means any WCD which is able to establish communications with a BTS connected to a common BSC 110. FIG. 1 is illustrative of the major functional blocks comprising communication system 100.

When a first WCD, such as WCD 102, initiates an asynchronous data communication, generally an origination message is transmitted by WCD 102 to a BTS through which communications are possible. In this example, WCD 102 is in communication with BTS 106, therefore the origination message transmitted by WCD 102 is received by BTS 106.

The origination message comprises information relating to the type of communication desired, for example a voice communication, a synchronous data communication, or an asynchronous data communication. In addition, the origination message generally comprises an identification code identifying the desired destination device to which communications are sought. In this example, WCD 102 desires an asynchronous data communication with WCD 104. The identification code generally comprises a telephone number associated with WCD 104, although any other alpha-numeric identifier could be used in the alternative, such as an electronic serial number (ESN) or a mobile serial number (MSN), both of which are well-known in the art.

The origination message is received by BTS 106 and is then provided to BSC 110. In one embodiment, BSC 110 receives the origination message and determines if the origination message comprises a request to initiate asynchronous data communications. If the origination message contains such a request, then BSC 110 next determines whether the identification code contained within the origination message identifies WCD 104 as operating within communication system 100. To determine this, BSC 100 queries VLR 122 and/or HLR 122, in one embodiment. If the identification code is found within VLR 122, this generally signifies that WCD 104 is operating within communication system 100. In an alternative embodiment, BSC 110 queries HLR 124 to determine whether WCD 104 is operating within communication system 100.

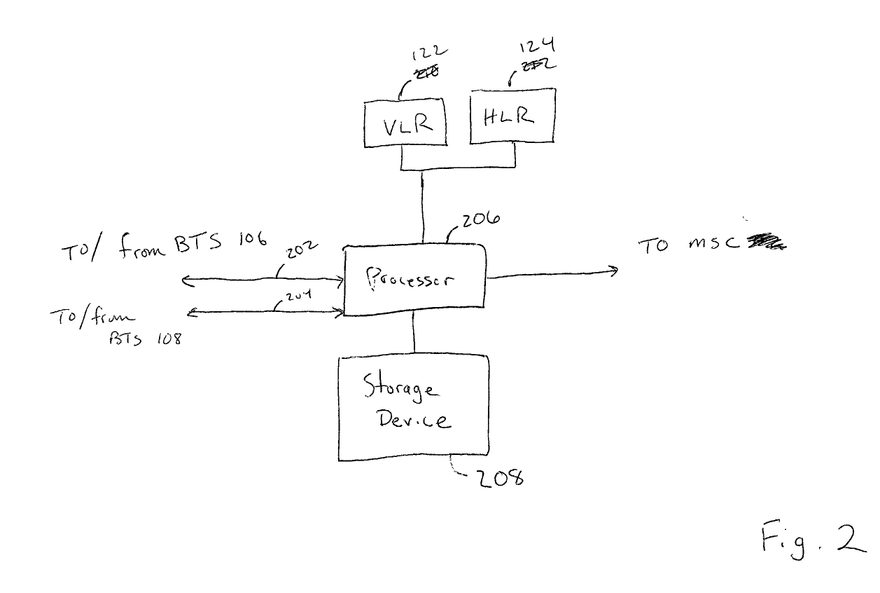

FIG. 2 is a functional block diagram of BSC 110 illustrating the various components comprising the apparatus for providing fast mobile-to-mobile data connectivity. Other components of BSC are not shown in FIG. 2 for purposes of clarity. Although FIG. 2 illustrates the functional components for providing fast mobile-to-mobile connectivity as being located within BSC 110, it should be understood that these functional components may alternatively reside in BTS 106 or reside partially within BSC 110 and partially within BTS 106, or they could reside in an entity other than BSC 110 or BTS 106.

Communications between BSC 110 and various BTSs are transmitted over backhaul lines 202 and 204, corresponding to BTS 106 and BTS 108, respectively. Each BTS in communication system 100 is connected to BSC 110, generally by these backhaul lines. The backhaul lines generally include any communication channel capable of the transmission of a large number of simultaneous communications, such as a T1 or a T3 line, one or more fiber optic cables, and the like. For purposes of clarity only backhaul lines 202 and 204 are shown in FIG. 2, although in practice, a number of backhaul lines are generally routed from multiple BTSs to BSC 110.

When WCD 102 desires an asynchronous data communication with another WCD within communication system 100, for example WCD 104 operating within the coverage area of BTS 108, an origination message is transmitted by WCD 102 and received by BTS 106. The origination message is downconverted and demodulated into a format suitable for transmission over backhaul line 202, such as pulse code modulated (PCM) format. Of course, other formatting options well known in the art could be used in the alternative. In another embodiment, the origination message is processed at BTS 106, using the components shown in FIG. 2.

When the origination message is received by processor 206, it is examined to determine if it comprises a request to initiate an asynchronous data communication, as opposed to a voice communication or a synchronous data communication, for example. In general, the origination message contains a field representative of the type of communications desired. For example, the designated field may comprise four bits, representing sixteen possible communication types. If the origination message does not contain a request to initiate an asynchronous data communication, processor 206 routes the origination message in accordance with known principles for establishing communications between WCD 102 and the desired destination device. Generally, this entails forwarding the origination message to switch 112, where resources are allocated in order to implement the subsequent communication.

Processor 206 comprises one or more digital microprocessors which are generally known in the art, such as any one of the Pentium microprocessors manufactured by Intel Corporation of Santa Clara, Calif. Alternatively, processor 206 comprises an application specific integrated circuit (ASIC), or discrete components. In one embodiment, processor 206 comprises a bank of individual processors, each processor responsible for communications with a respective BTS. Other configurations are possible.

Processor 206 executes a series of executable computer instructions which are stored in storage device 208. Storage device 208 comprises an electronic memory, such as random access memory (RAM), a disk drive, read only memory (ROM), flash RAM, or other such memory devices known in the art. The executable computer instructions are executed by processor 206 when an origination message is received.

If processor 206 determines that the origination message comprises a request to initiate an asynchronous data communication, processor 206 then determines whether the desired destination device is operating within communication system 100. If the desired destination device is not operating within communication system 100, the origination message is forwarded to switch 112 for normal processing. That is, switch 112 allocates the necessary resources to allow the subsequent asynchronous data communication to take place with the desired destination device operating outside of communication system 100. If the desired destination device is operating within communication system 100, then processor 206 routes the subsequent data communication directly to the desired destination device, bypassing switch 112 and, therefore, eliminating the need to use modems and their associated modem training time. However, information other than the data communication itself may be passed to switch 112 from processor 206 for other purposes, such as billing information, the location of a WCD, etc.

Processor 206 determines where the desired destination device is operating by consulting VLR 122, HLR 124, or both. The origination message comprises an identification code corresponding to the desired destination device. The identification code typically comprises a telephone number, although other means to identify the desired destination device could be used in the alternative, such as a mobile identification number (MIN), an electronic serial number (ESN), or a data address, such as an Internet Protocol (IP) address.

In one embodiment, the identification code is provided to VLR 122 by processor 206. VLR 122 comprises a database containing information pertaining to the status of WCDs operating within communication system 100. When a WCD is registers with communication system 100, a registration message is sent by the WCD to processor 206, and then forwarded to VLR 122 and HLR 124. The registration message comprises information as to which BTS the WCD is operating within as well as the identification code corresponding to the reporting WCD. Other information may be provided as well, such as a geographic position of the WCD, or information pertaining to the type of communications (voice, asynchronous data, synchronous data, etc.) the WCD is authorized to receive.

Processor 206 determines whether or not the desired destination device is operating within communication system 100 by examining VLR 122 to determine if the desired destination device corresponding to the identification code is present. In other words, if the desired destination device has registered with communication system 100, VLR 122 will reflect the registration and record the pertinent details of the registration, and processor 206 will find the registration when it queries VLR 122. Alternatively, HLR 124 is queried by processor 206 to determine the operational status of the desired destination device.

If processor 206 determines that the desired destination device is operating within communication system 100, processor 206 routes the subsequent asynchronous data communication directly to the desired destination device without sending the data through a modem. In one embodiment, processor 206 reformats the data packets comprising the asynchronous data communication so that the reformatted packets are sent to the BTS identified by information contained within VLR 122 and/or HLR 124. As explained above, VLR 122 and/or HLR 124 will contain such information for each WCD registered in communication system 100. Processor 206 may send information pertaining to the various aspects of the data communication to switch 112 for billing or other purposes.

If BSC 110 determines that WCD 104 is operating within communication system 100, then the communication does not need to be routed to switch 112. Instead, BSC 110 determines which BTS WCD 104 is operating within and routes the data communication from WCD 102 to WCD 104 without the use of modems. Therefore, because the use of modems is eliminated, the delay associated with the modem training period is also eliminated, and the delay in establishing communications with WCD 104 is minimized.

In the example of FIG. 1, WCD 104 is operating within the coverage area of BTS 108, therefore BSC 110 directs the data communication from WCD 102 to BTS 108, where communications are established with WCD 104. WCD 104 is informed of an available data communication by any well-known method known in the art, such as an audible, visual, or tactile alert to a user of WCD 104.

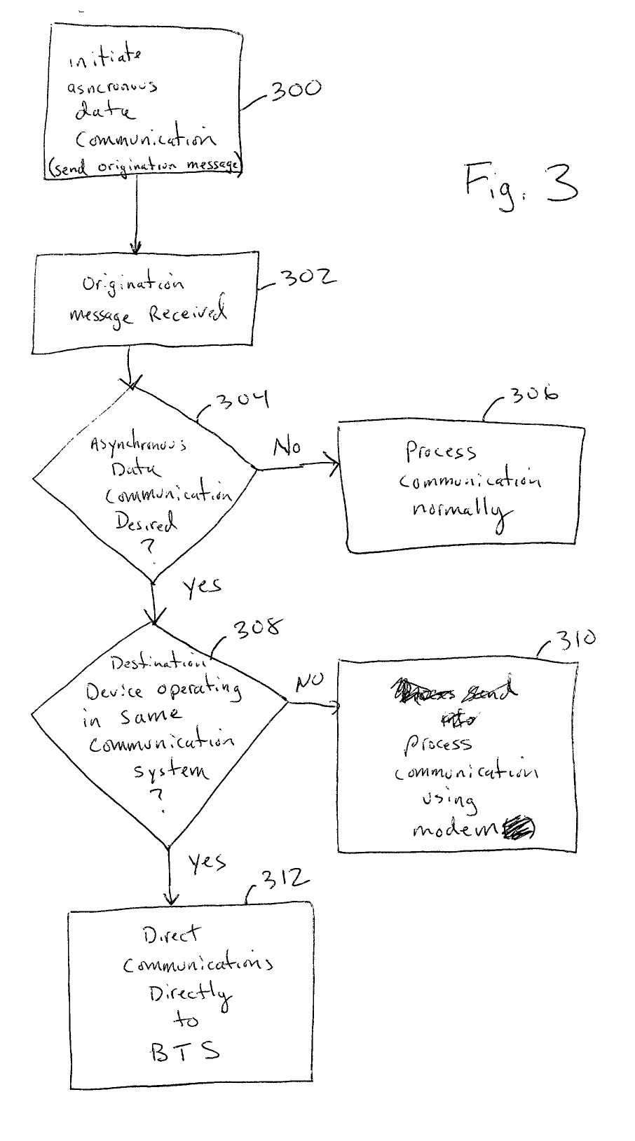

FIG. 3 is a functional flow diagram of the method of providing fast mobile-to-mobile data connectivity. In step 300, WCD 102 initiates an asynchronous data communication with WCD 104 by transmitting an origination message. The origination message comprises information relating to the type of communication desired, for example asynchronous data communications. In addition, the origination message generally comprises a identification code identifying the desired destination device to which communications are desired, in this case, WCD 104.

In step 302, the origination message is received by BTS 106 and is either processed by BTS 106 or passed onto BSC 110.

In step 304, a processor determines whether or not asynchronous data communications are desired by examining the origination message. If asynchronous communications are not desired, processing continues to step 306, where the communication is handled normally. That is, if the origination message from WCD 102 requests voice service or synchronous data communications, BSC 110 operates to establish the desired communication type by using processes well known to those skilled in the art.

If the origination message requests asynchronous data communications, processing continues to step 308 where the identification code is examined to determine if WCD 104 is operating within communication system 100. Generally, this is accomplished by BSC 110 querying VLR 122, however it could alternatively be accomplished by querying HLR 124. If WCD 104 is found not to be operating within communication system 100, processing continues to step 310, where the asynchronous data communication is processed in accordance with generally known processing techniques. For example, the origination message is forwarded to switch 112, where resources are allocated to establish communications with a desired destination device outside of communication system 100. This generally involves the use of a modem located in modem bank 114.

If it is determined in step 308 that WCD 104 is operating within communication system 100, then processing continues to step 312, where BSC 110 directs the asynchronous communication to WCD 104 through a BTS in which WCD 104 is operating within. In the current example, BSC 110 routes the asynchronous data communication to BTS 108 where communications are initialized with WCD 104. Note that the asynchronous data communications from WCD 102 are not routed through switch 112, nor is the use of a modem necessary in order to effectuate data communications between WCD 102 and WCD 104. This reduces the delay associated with the modem training period, as discussed above.

The previous description of the preferred embodiments is provided to enable any person skilled in the art to make or use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

We claim:

1. An apparatus for providing fast mobile-to-mobile connectivity during an asynchronous data communication, comprising:
a processor; and
a storage device coupled to said processor and containing a set of executable computer instructions for:
determining if an initial communication from a first wireless communication device operating in a wireless communication system comprises a request to initiate an asynchronous data communication;
determining an identification code associated with a second wireless communication device, said identification code determined from said initial communication;
determining if said second wireless communication device is operating within said wireless communication system; and
routing said asynchronous data communication to said second wireless communication device without the use of a modem if said initial communication comprises a request to initiate said asynchronous communication and said second wireless communication device is operating within said wireless communication system.

2. The apparatus of claim 1 further comprising a database for storing a list of wireless communication devices operating within said communication system, wherein said processor determines if said second wireless communication device is operating within said communication system by determining if said second wireless communication device is listed in said database.

3. The apparatus of claim 2 wherein said database comprises a visitor location register.

4. A method for providing fast mobile-to-mobile connectivity during an asynchronous data communication, comprising the steps of:
receiving an initial communication from a first wireless communication device operating in a wireless communication system;
determining if said initial communication comprises a request to initiate an asynchronous data communication;
determining an identification code corresponding to a second wireless communication device, said identification code determined from said initial communication;
determining if said second wireless communication device is operating within said wireless communication system; and
routing said asynchronous data communication to said second wireless communication device without the use of a modem if said initial communication comprises a request to initiate said asynchronous communication and said second wireless communication device is operating within said communication system.

5. The method of claim 4 wherein the step of determining if said second wireless communication device is operating within said communication system comprises the step of determining if said second wireless communication device is listed in a database, said database for storing a list of wireless communication devices operating within said communication system.
